(19) United States
(12) Patent Application Publication
(10) Pub. No.: US 2013/0124605 A1
(43) Pub. Date: May 16, 2013

(54) AGGREGATING AND PRESENTING TASKS

(71) Applicants: Eilene Hao Klaka, Redmond, WA (US); Andrew Richard Cuneo, Seattle, WA (US); Jesse Gilbert Carnathan, Seattle, WA (US); Bryan Thomas Phelps, Seattle, WA (US); Elena Popa, Redmond, WA (US); Ionela Mirela Vals, Redmond, WA (US); Ronald J. Curtis, Sammamish, WA (US)

(72) Inventors: Eilene Hao Klaka, Redmond, WA (US); Andrew Richard Cuneo, Seattle, WA (US); Jesse Gilbert Carnathan, Seattle, WA (US); Bryan Thomas Phelps, Seattle, WA (US); Elena Popa, Redmond, WA (US); Ionela Mirela Vals, Redmond, WA (US); Ronald J. Curtis, Sammamish, WA (US)

(73) Assignee: Microsoft Corporation, Redmond, WA (US)

(21) Appl. No.: 13/295,113

(22) Filed: Nov. 14, 2011

(51) Int. Cl. G06F 15/16

(52) U.S. Cl. 709/203

(57) ABSTRACT

Concepts and technologies are described herein for aggregating and presenting tasks. A task engine communicates with task systems that host tasks. The tasks are rendered in a user interface provided by the task engine. Changes to the tasks within the user interface can be written to the task systems and to copies of the tasks stored in a cache associated with the task engine. In some embodiments, the tasks are stored at the task systems and referenced by the user interface provided by the task engine. Thus, changes to the tasks can be written to the tasks stored at the task systems. User interfaces for viewing and editing the tasks are also provided.

### BACKGROUND

Workers may use multiple software applications to manage work, schedules, tasks, timelines, and/or other aspects of their work. Often, these software applications use disparate and/or incompatible approaches to represent work, to indicate or track time-based aspects of particular tasks, and/or to communicate with other software. As such, workers may manage various aspects of their work using multiple software applications.

Some software applications are capable of exporting data corresponding to work, tasks, or other information associated with users. This exported data may be imported into some software, but may not be compatible with some other software. As such, while the ability to export data may be helpful in some instances, the usefulness can be diminished if a worker uses incompatible software.

Furthermore, the exported data may be outdated or irrelevant when imported into other software applications. For example, a worker may complete work represented by exported data after the data has been exported. As such, if the data is imported into a compatible software package, the completed work may be represented as work that has not been completed. To correct this, the worker may update the status of the work in the original software application that exported the data to indicate the completion of the work, re-export the data, and re-import the data into the software application.

It is with respect to these and other considerations that the disclosure made herein is presented.

### SUMMARY

Concepts and technologies are described herein for aggregating and presenting tasks. In accordance with the concepts and technologies disclosed herein, a system can include a task engine that communicates with task systems. The task systems host or manage tasks associated with a user. In some embodiments, the task engine is configured to obtain copies of the tasks from the task systems, aggregate the tasks, and store the aggregated tasks in a cache or other data storage device associated with the task engine. In other embodiments, the task engine is configured to reference the tasks stored or hosted by the task systems without obtaining a local copy of the tasks.

The task engine also is configured to generate and present one or more user interfaces for viewing and managing the aggregated tasks. The user interfaces can include a view for presenting tasks with recent or upcoming deadlines, deadlines for a current day, a view for presenting new tasks, a view for presenting completed tasks, a view for presenting all tasks, and other views. In some embodiments, one or more of the views include a timeline for presenting aggregated tasks. Aggregated tasks displayed by the user interfaces can be interacted with by users, for example to modify the tasks, to mark the tasks as important or completed, and/or for other reasons. Modifications made to the tasks can be written to copies of the tasks within the cache and/or to the task systems hosting, creating, and/or storing the tasks.

According to one aspect, a task engine communicates with two or more task systems that store tasks. The task engine aggregates tasks by obtaining copies of the tasks from the two or more task systems via an application programming interface exposed by the task engine. The aggregated tasks are stored at a cache or other data storage device associated with the task engine. A user interface for presenting the aggregated tasks is generated by the task engine and presented to a user or other entity. In other embodiments, the aggregated tasks are shared with other systems or consumers via the application programming interface.

According to another aspect, the user interface generated by the task engine includes functionality for modifying one or more of the aggregated tasks. Modifications made to the aggregated tasks can be written to copies of the tasks stored by the task engine and/or can be made directly to tasks hosted or stored by the task systems. As such, embodiments of the concepts and technologies disclosed herein allow users to aggregate tasks from multiple disparate task systems, view the aggregated tasks in a single user interface, interact with the presented aggregated tasks, and write modifications to the aggregated tasks back to task systems from which the tasks were obtained.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein.

FIG. 2 is a flow diagram showing aspects of a method for aggregating tasks, according to an illustrative embodiment.

FIG. 3 is a flow diagram showing aspects of a method for presenting aggregated tasks, according to an illustrative embodiment.

FIGS. 4A-4F are user interface diagrams showing aspects of user interfaces for presenting and managing tasks, according to various illustrative embodiments.

FIG. 5 is a computer architecture diagram showing an illustrative computer hardware and software architecture for a computing system capable of implementing aspects of the embodiments presented herein.

FIG. 6 is a diagram illustrating a distributed computing environment capable of implementing aspects of the embodiments presented herein.

FIG. 7 is a computer architecture diagram illustrating a computing device architecture capable of implementing aspects of the embodiments presented herein.

FIG. 8 is a diagram illustrating a user interacting with a user interface provided by a tablet computer, according to an illustrative embodiment.

### DETAILED DESCRIPTION

The following detailed description is directed to concepts and technologies for aggregating and presenting tasks. According to the concepts and technologies described herein, a task engine communicates with multiple task systems. The task systems host or manage tasks and are configured to expose or provide the tasks to the task engine for aggregation. In some embodiments, the aggregated tasks are presented by the task engine without storing the tasks. In other embodiments, the task engine is configured to aggregate the tasks and store the aggregated tasks in a cache or other data storage device associated with the task engine.

The task engine also is configured to generate and present one or more user interfaces for viewing and managing the aggregated tasks. The user interfaces can be used to present the aggregated tasks stored in a cache or stored by the task systems. Thus, in some embodiments the task engine embeds references to the tasks in the user interfaces while in other embodiments, the task engine uses copies of the tasks stored in the cache to generate the user interfaces. Aggregated tasks displayed in the user interfaces can be interacted with by users, for example to modify the tasks, to mark the tasks as important or completed, and/or for other reasons. Modifications made to the tasks can be written to copies of the tasks within the cache and/or to the tasks hosted or stored by the task systems.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for aggregating and presenting tasks will be presented.

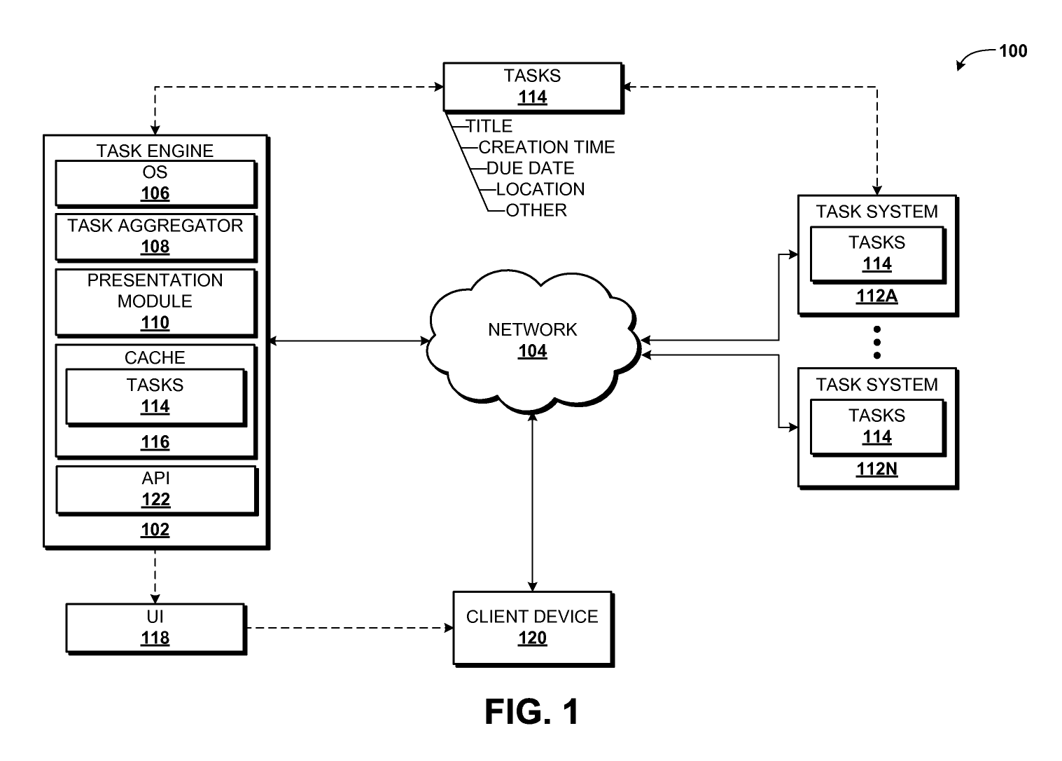

Referring now to FIG. 1, aspects of one operating environment 100 for the various embodiments presented herein will be described. The operating environment 100 shown in FIG. 1 includes a task engine 102 operating as part of or in communication with a network 104. The task engine 102 is configured to execute an operating system 106 and one or more application programs such as, for example, a task aggregator 108, a presentation module 110, and/or other application programs.

The operating system 106 is a computer program for controlling the operation of the task engine 102. The task aggregator 108 and the presentation module 110 are executable programs configured to execute on top of the operating system 106 to provide the functionality described herein for aggregating and presenting tasks, as is explained in more detail herein. Although the task aggregator 108 and the presentation module 110 are illustrated as components of the task engine 102, it should be understood that each of these components, or combinations thereof, may be embodied as or in stand-alone devices or components thereof operating as part of or in communication with the network 104 and/or the task engine 102. Additionally, in some embodiments the task engine 102 is provided by one or more devices executing a member of the MICROSOFT SHAREPOINT family of collaboration products from Microsoft Corporation in Redmond, Wash., the functionality of one or more of the task aggregator 108 and/or the presentation module 110 are provided by services executing within MICROSOFT SHAREPOINT. As such, the illustrated embodiment is illustrative, and should not be construed as being limiting in any way.

The task aggregator 108 is configured to communicate with one or more task systems 112A-N (hereinafter referred to generically or collectively as “task systems 112”) to obtain one or more tasks 114 hosted or stored by the task systems 112. According to various implementations, the functionality of the task systems 112 is provided by one or more server computers or other computing devices operating as part of or in communication with the network 104 and/or in communication with the task engine 102. As used herein, a “task” is data that represents a particular work task, job, operation, process, milestone, or other aspect of work. For example, a task associated with a project for building a website can include, for example, creating a home page banner. Another task associated with the same project can include authoring code for one or more parts of the page. Because the tasks 114 can include any aspect of any type of work, it should be understood that these embodiments are illustrative, and should not be construed as being limiting in any way.

According to various embodiments, the tasks 114 are represented by data that can include various types of information associated with the work to which the tasks 114 relate. For example, the tasks 114 can include a title for the task 114, a creation time and date (“creation date”) for the task 114, a due date for the task 114, a location associated with the task 114, and other information associated with the task 114. The location of the task 114 can correspond to a URL or resource location for the task system 112 from which the task 114 is obtained, for example, or another location. The other information can include, but is not limited to, a flag indicator that indicates if the task 114 has been flagged by a user or other entity, a completion state for the task 114 that indicates a level of completeness associated with the task 114, a project with which the task 114 is associated, a team or other user associated with the task 114 and/or other information. A “flag” can include a binary yes/no or true/false indication of whether a user identifies a task 114 as important or for follow-up, or can include other non-binary indications of relative importance such as letter grades, numerical scales, combinations thereof, a time at which the importance flag is to expire, and the like. The tasks 114 can include any desired information, and the information can be, but is not necessarily, used by the task aggregator 108 to organize and/or catalogue the tasks 114 and/or the presentation module 110 to present the tasks 114.

The task aggregator 108 is configured to communicate with the task systems 112 to obtain data corresponding to the tasks 114. In some embodiments, the task aggregator 108 communicates with the task systems 112 to request the tasks 114, to recognize received data as the tasks 114, to organize and/or catalogue the tasks 114, if desired, and/or to store the tasks 114 in a data storage location. In other embodiments, the task engine 102 is configured to allow task systems 112 to communicate with the task aggregator 108. Thus, the task systems 112 can be configured to communicate with the task engine 102 to submit the tasks 114, and the task aggregator 108 can be configured to recognize the submitted data as the tasks 114 and store the tasks 114 in a data storage device with or without organizing and/or cataloguing the tasks 114.

In some embodiments, the task aggregator 108 is configured to store the tasks 114 in a cache 116. The cache 116 can be hosted by or can be in communication with the task engine 102. In some embodiments, the functionality of the cache 116 is provided by a memory device, a hard drive, or other storage device of the device providing the functionality of the task engine 102. In other embodiments, the functionality of the cache 116 is provided by one or more data storage devices in communication with the task engine 102 such as, for example, one or more databases, server computers, mass storage devices, memory devices, combinations thereof, and the like. It therefore should be understood that the tasks 114 can be stored at a data storage device that is integrated into, or remote from, the task engine 102. Thus, the embodiment shown in FIG. 1 is illustrative, and should not be construed as being limiting in any way.

The task aggregator 108 also is configured to communicate with the task systems 112 to write changes made to tasks 114 to the task systems 112. As will be explained in more detail herein, the tasks 114 can be presented to one or more users or other entities (“users”) via one or more user interfaces (“UIs”) 118. The UIs 118 also can enable users to manage the tasks 114. For example, the users can delete or indicate as completed tasks 114 that are completed. This indication can be captured and provided to the task aggregator 108. The task aggregator 108 can be configured to communicate the indication to the task systems 112 to update the tasks 114 stored by the tasks systems 112.

The presentation module 110 is configured to generate and present the UIs 118 to the users. As mentioned above, the users can include software users, other software applications, other systems, and/or other entities. In the illustrated embodiment, the user is illustrated as a client device 120 operating in communication with the task engine 102 via the network 104. This embodiment is illustrative and is provided to simply description of the concepts and technologies disclosed herein. In some embodiments, for example, the user can correspond to a task system 112 such as a server computer executing a member of the MICROSOFT EXCHANGE family of products from Microsoft Corporation in Redmond, Wash. (an “EXCHANGE server”). The EXCHANGE server can provide or expose tasks 114 to the task engine 102 for aggregation and/or can consume aggregated tasks via the UIs 118 and/or via an application program interface (“API”) 122 exposed by the task engine 102 to aggregate tasks 114. The API 122 also can be exposed by the task engine 102 to allow the task systems 112 to submit the tasks 114 to the task aggregator 108. As such, the term “user” as used herein should be understood as referring to a broad range of systems, users, devices, components, and the like, and the illustrated embodiment should not be construed as being limiting in any way.

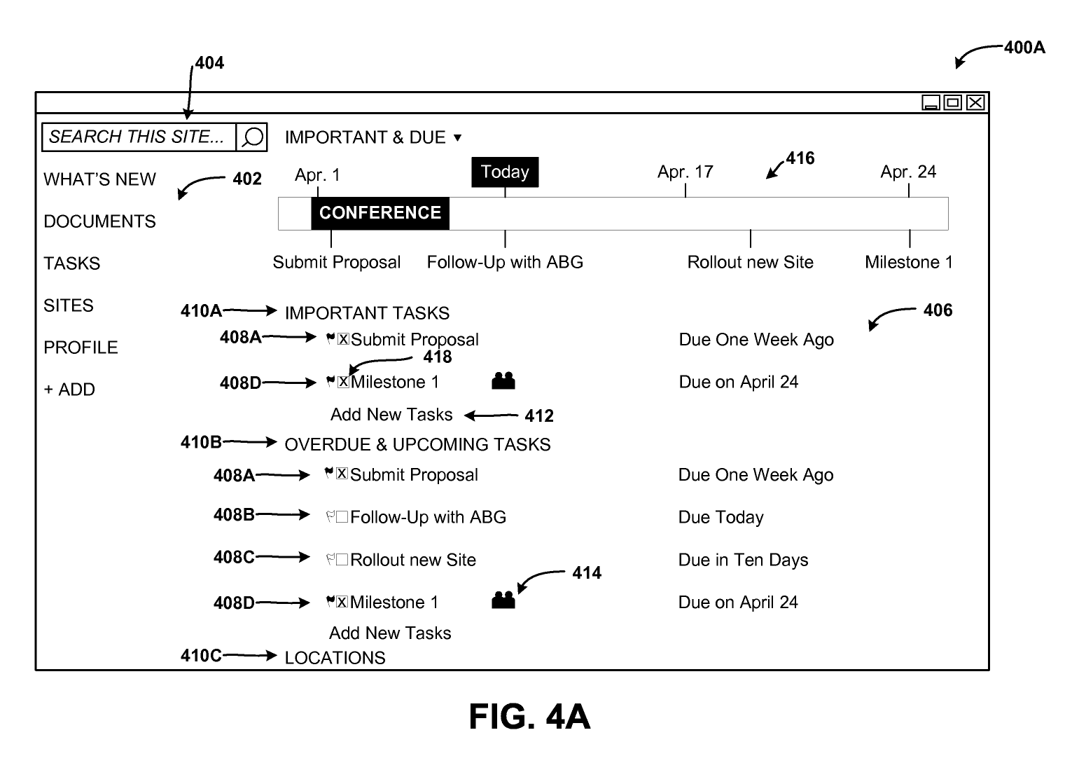

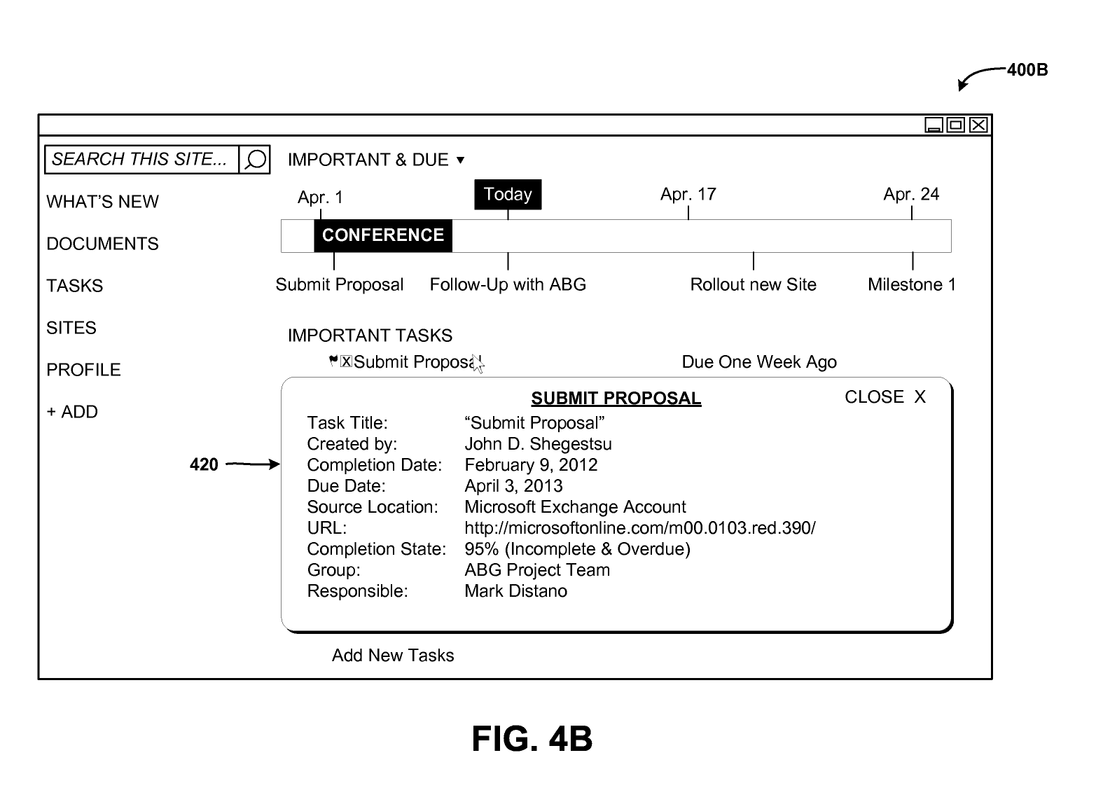

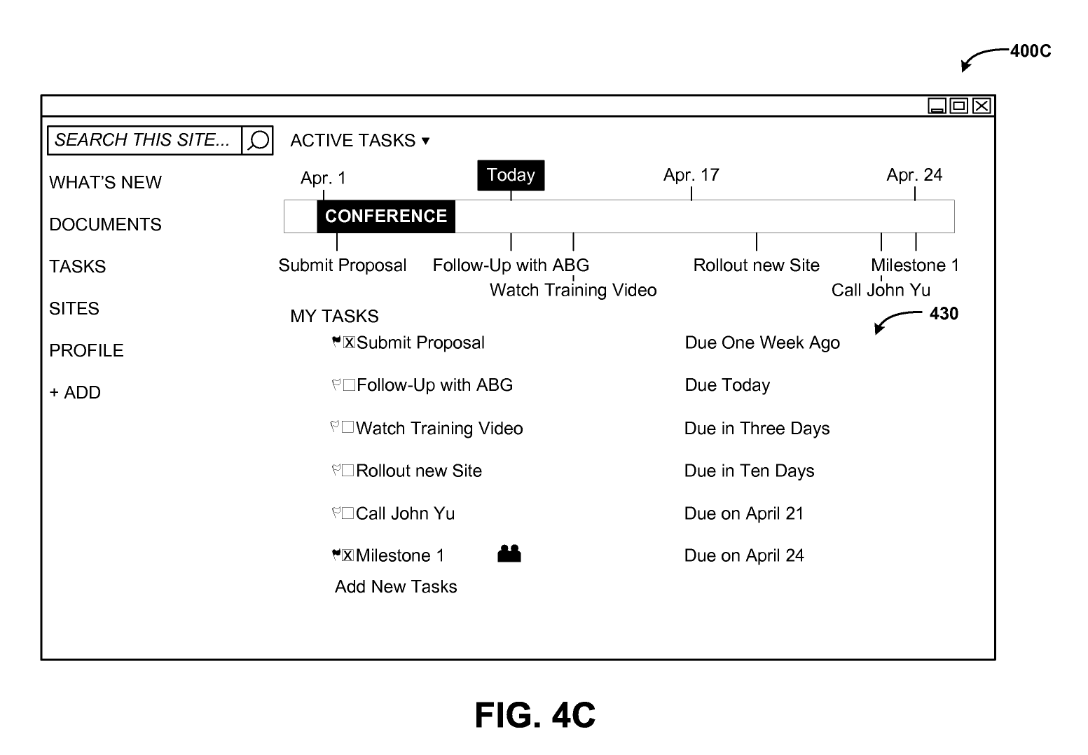

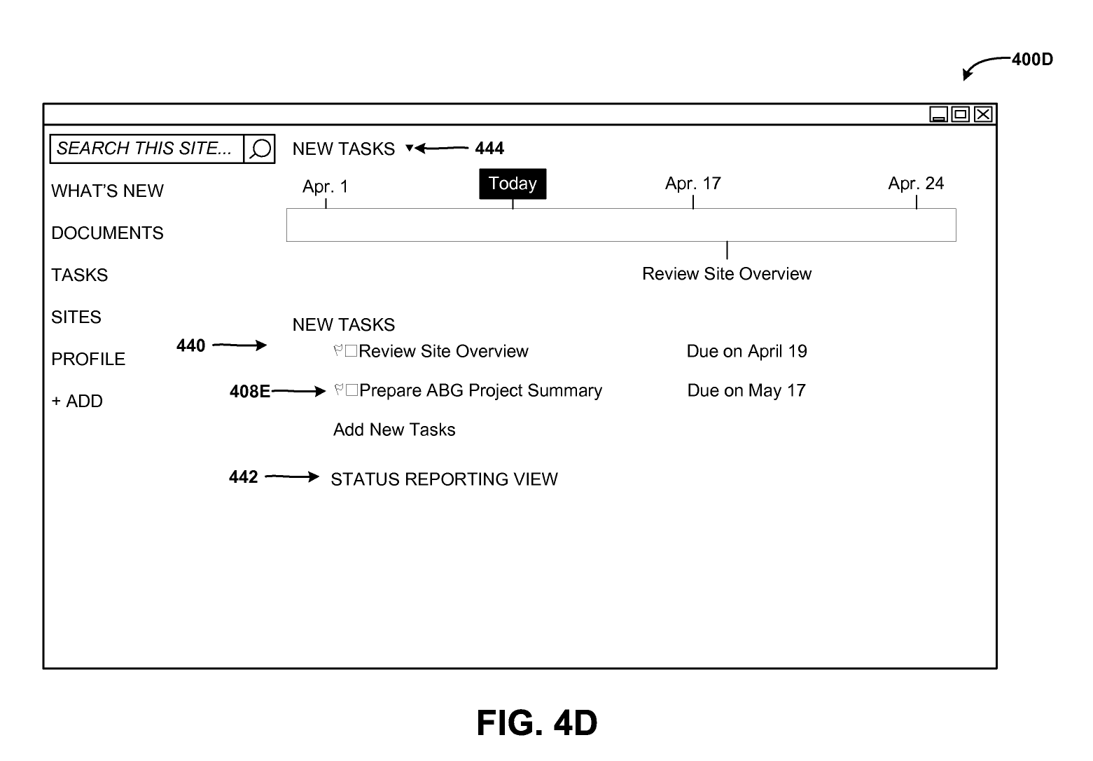

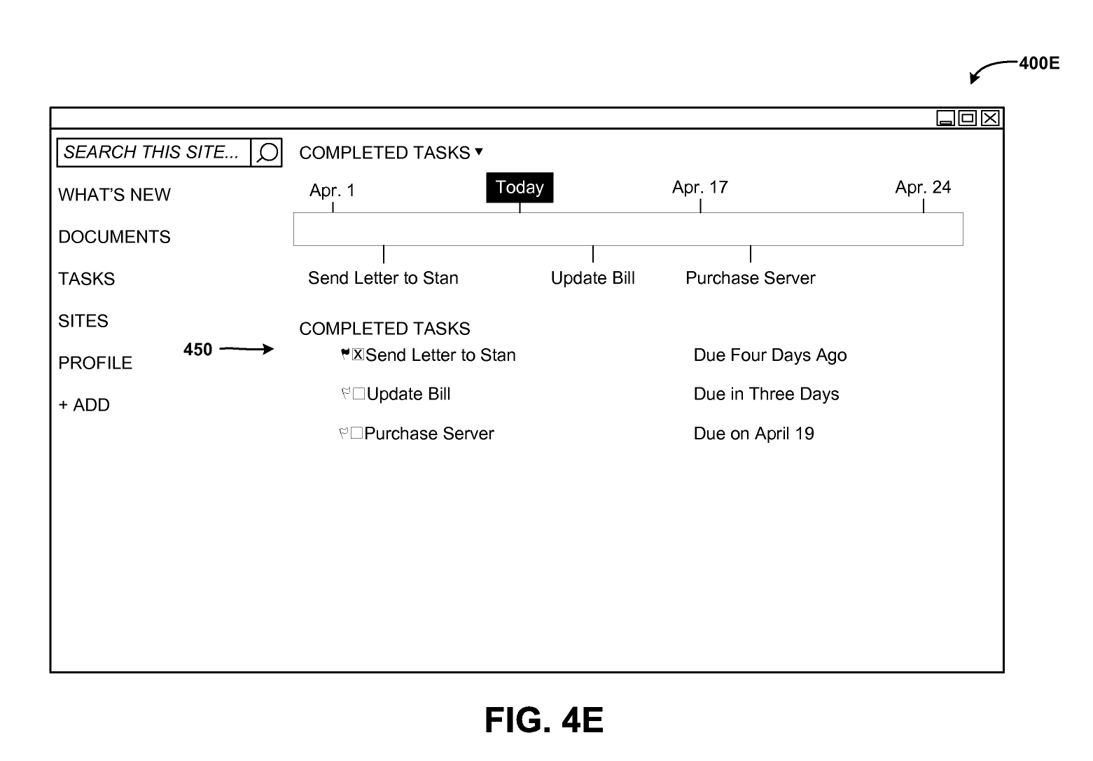

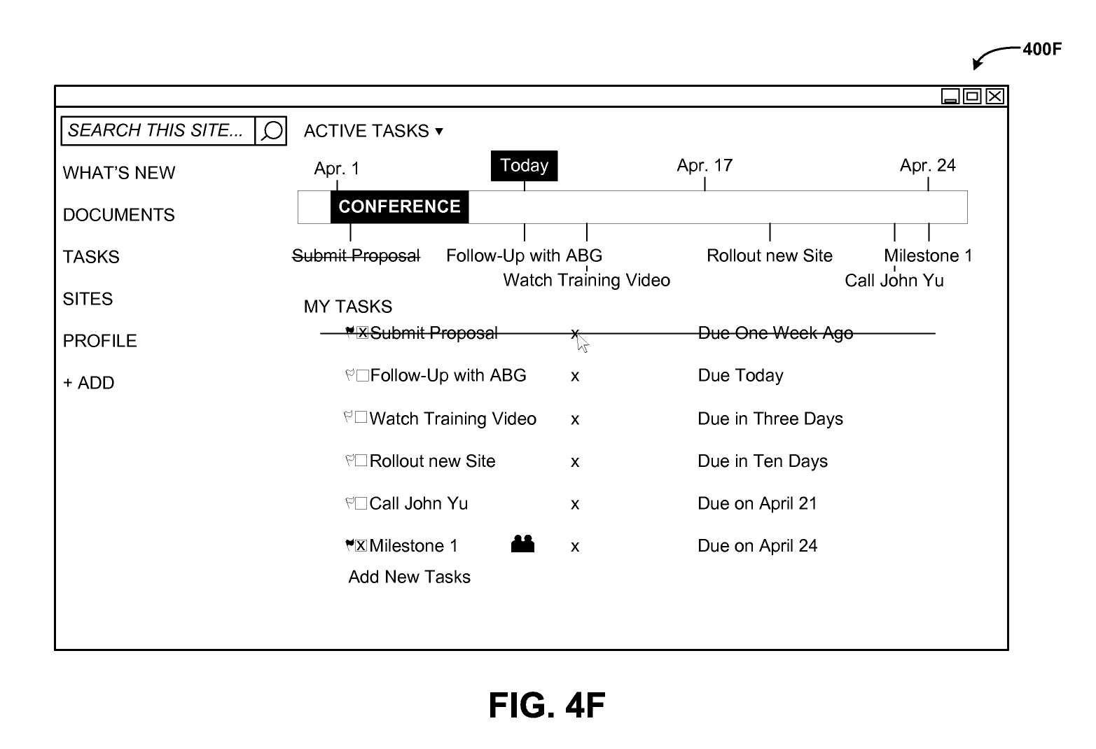

The presentation module 110 can provide any number of UIs 118 to users for interaction with the tasks 114, and can communicate with the task aggregator 108 to indicate changes made to the tasks 114 by the users. Some example UIs 118 are illustrated below with reference to FIGS. 4A-4E. As will be more clearly understood with reference to these and other FIGURES described herein, the presentation module 110 can be configured to obtain the tasks 114 aggregated by the task aggregator 108 and to present the aggregated tasks 114 in the UIs 118.

In some embodiments, the presentation module 110 also can be configured to present one or more UIs 118 for allowing users to create tasks 114 within the task engine 102. Thus, tasks 114 can be created at the task engine 102 and may not be aggregated from a task system 112. As such, the task engine 102 can function, in some instances, as a task system 112. Tasks 114 created at the task engine 102 can be stored in the cache 116 and/or can be shared with other task systems 112, clients, and/or other devices.

In some embodiments, the task engine 102 supports aggregation and presentation of the tasks 114 without storing the tasks 114 at the cache 116. In particular, some embodiments of the task engine 102 are configured to show tasks 114 stored at the task systems 112 in the UIs 118. Furthermore, the task engine 102 can be configured to support creation of tasks 114 at the task engine 102 and synchronization of the created tasks to the task systems 112, if desired. For example, the tasks 114 can be embedded in the UIs 118 as external references to the tasks 114 stored or hosted by the task systems 112. As such, users can interact with and/or modify tasks 114 directly at the task systems 112 without directly accessing the task systems 112. Furthermore, changes made to the tasks 114 can be made directly to the tasks 114 stored at the task systems 112 and as such can be instantly reflected in the tasks 112 stored by the task systems 112.

In some embodiments, a user authenticates at the task engine 102. For example, as mentioned above, some embodiments of the task engine 102 are provided by a computing device executing a member of the MICROSOFT SHAREPOINT family of collaboration products from Microsoft Corporation in Redmond, Wash. Thus, a user may be authenticated or identified by the task engine 102 and the task engine 102 can log into and/or authenticate with one or more task systems 112 that require authentication or login. Because authentication and login are generally understood, these aspects of the task engine 102 are not described in further detail herein for the sake of brevity.

FIG. 1 illustrates one task engine 102, one network 104, two task systems 112, and one client device 120. It should be understood, however, that some implementations of the operating environment 100 include multiple task engines 102, multiple networks 104, one or more than two tasks systems 114, and/or multiple client devices 120. Thus, the illustrated embodiments should be understood as being illustrative, and should not be construed as being limiting in any way.

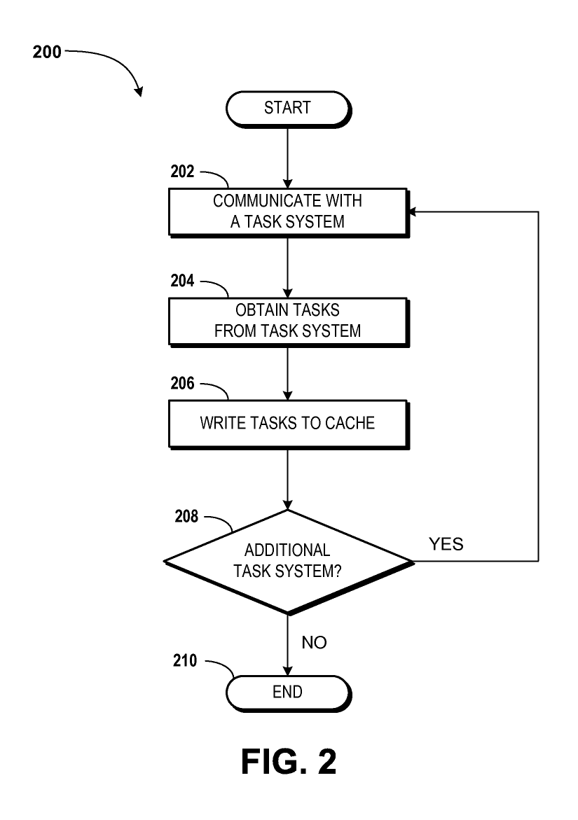

Turning now to FIG. 2, aspects of a method 200 for aggregating tasks 114 will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the task engine 102 via execution of the task aggregator 108 and/or the presentation module 110. It should be understood that these embodiments are illustrative, and should not be viewed as being limiting in any way. In particular, devices other than the task engine 102 can provide the functionality described herein by execution of any applications or modules including, but not limited to, the task aggregator 108 and/or the presentation module 110.

The method 200 begins at operation 202, wherein the task engine 102 communicates with a task system 112. As explained above, communications between the task engine 102 and the task system 112 can be initiated and/or conducted in a number of ways. In some embodiments, the task engine 102 connects to a task system 112. Thus, operation 202 can include the task engine 102 connecting to a task system 112, authenticating with the task system 112, if desired, and/or identifying a user or system for which tasks 114 are to be aggregated.

In other embodiments, as mentioned above, the task systems 112 can connect to the task engine 102. For example, the task engine 102 can expose the API 122 to the task systems 112 to allow the task systems 112 to communicate with the task aggregator 108 and/or other functionality of the task engine 102. A such, operation 202 can include the task system 112 accessing the task engine 102 via the API 122 and/or other interfaces associated with the task engine 102. Although not explained in detail above, the tasks systems 112 can be authenticated by the task engine 102, if desired, prior to being allowed to submit tasks 114.

From operation 202, the method 200 proceeds to operation 204, wherein the task engine 102 obtains tasks 114 from a task system 112. As explained herein, the tasks 114 can be submitted to the task engine 102 by the task systems 112 in response to a request from the task engine 102, or can submitted by the task systems 112 without being explicitly requested by the task engine 102. In some embodiments, the task engine 102 requests or receives the tasks 114 based upon expiration of timer job executed by the task engine 102 and/or the task systems 112. In other embodiments, the task aggregator 108 is configured to request an update of tasks 114 stored in the cache 116 after the tasks 114 are read by the presentation module 110 and/or presented to a user via the UI 118. Thus, the tasks 114 can be requested or updated at any time including, but not limited to, during presentation of the tasks 114 to a user.

From operation 204, the method 200 proceeds to operation 206, wherein the task engine 102 writes the tasks 114 to the cache 116. The tasks 114 written to the cache 116 in operation 206 can include new tasks 114 that have not previously existed in the cache 116, indications that one or more tasks 114 stored in the cache 116 are to be deleted, and/or duplicate or modified versions of tasks 114 stored in the cache 116. Thus, operation 206 can include writing new tasks 114, deleting tasks 114, updating tasks 114, and the like.

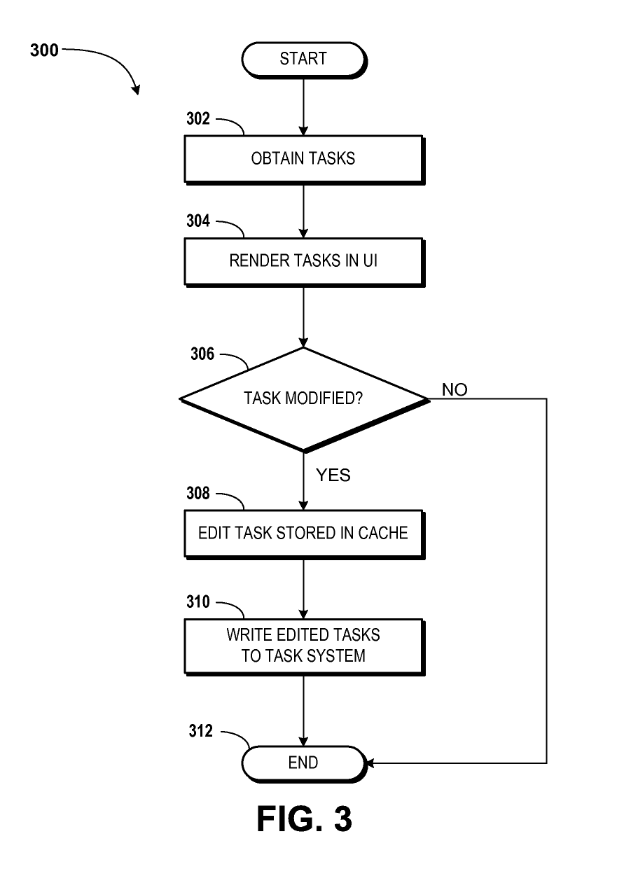

As explained above with reference to FIG. 1, some embodiments of the concepts and technologies disclosed herein include in-place presentation and/or editing of tasks 114 at task systems 112 via the task engine 102. As such, in some embodiments the tasks 114 can be aggregated and presented without caching the tasks 114. This embodiment is illustrated below in FIG. 3.

From operation 206, the method 200 proceeds to operation 208, wherein the task engine 102 determines if another task system 112 hosting tasks 114 exists. As explained above, the task engine 102 can aggregate tasks 114 from any number of task systems 112. As such, operation 208 can include determining if tasks 114 have been received or obtained from each task system 112.

If the task engine 102 determines, in operation 204, that another task system 112 exists, the method 200 returns to operation 202, wherein the task engine 102 communicates with another of the task systems 112. The operations 202-208 can be repeated until the task engine 102 determines, in any iteration of the operation 208, that tasks 114 have been obtained from the tasks systems 112 and/or that there is not an additional task system 112 from which to obtain tasks 114. If the task engine 102 determines, in operation 208, that there is not another task system 112 from which to obtain the tasks 114, the method 200 proceeds to operation 210. The method 200 ends at operation 210.

Turning now to FIG. 3, a method 300 for presenting tasks 114 will be described, according to an illustrative embodiment. The method 300 begins at operation 302, wherein the task engine 102 obtains tasks 114 associated with a user. In some embodiments, operation 302 includes obtaining the tasks 114 from the cache 116. As explained above with reference to FIG. 1, the tasks 114 can include data indicating a user associated with the task 114. As such, the cache 116 can be searched for tasks 114 associated with the user. In some implementations, only tasks 114 associated with the user are cached, so all cached tasks 114 may, by default, be associated with the user.

In other embodiments, the task 114 are obtained directly from the task systems 112 and presented to users without storing the tasks 114 in the cache 116. Thus, operation 302 can include accessing the task systems 112 and identifying tasks 114 hosted by the task systems 112 that are to be rendered by the task engine 102 for the user. As explained above, operation 302 can include authentication and/or communications completed via the API 122, if desired. As such, “obtaining” the tasks 114 for purposes of operation 302 can include receiving the tasks 114 at the task engine 102 and/or identifying the tasks 114 at the task systems 112.

From operation 302, the method 300 proceeds to operation 304, wherein the task engine 102 renders the tasks 114 obtained in operation 302 in a user interface such as the UIs 118. Some example user interfaces for presenting the tasks 114 are illustrated and described below with reference to FIGS. 4A-4E. As explained above, the user interfaces for presenting the tasks 114 also can be used to receive input from users. Thus, users can be enabled, by way of one or more user interface rendered presented in operation 304, to modify the tasks 114 and/or data associated with the various tasks 114. Although not shown in FIG. 3, some embodiments of the task engine 102 are configured to update the cache 116 before, after, or during rendering of the tasks 114 obtained in operation 302. As such, some embodiments of the method 300 include an operation for calling the task aggregator 108 to update the cache 116. It should be understood that this embodiment is illustrative, and should not be construed as being limiting in any way.

As will be illustrated and described in more detail below with reference to FIGS. 4A-4E, rendering the tasks 114 in one or more user interfaces can include rendering various views of the tasks 114 including, but not limited to, an “Important & Upcoming Tasks” view for displaying tasks 114 that are expected to be of highest priority to a user or other entity; a “Due Today” view that lists any tasks 114 due during the current calendar day and/or within twenty-four hours of a current time; an “Active Tasks” view that includes any tasks assigned to a particular user, regardless of relative importance or priority; a “Completed Tasks” view that shows any tasks marked as complete by a user; a “New Tasks” view that shows tasks identified since a previous rendering or cache refresh; and/or other views. In some embodiments, additional views can be based upon views supported by Project Server, if installed, and in some embodiments the list of views is extensible to views supported or provided by other task systems 112. The views also can include a timeline view for displaying tasks 114 throughout one or more of the views in a timeline interface. It should be understood that this embodiment is illustrative, and should not be construed as being limiting in any way.

From operation 304, the method 300 proceeds to operation 306, wherein the task engine 102 determines if a task 114, or data associated with the task 114, has been modified. Modifying a task 114 can include modifying any aspect of the task including, but not limited to, a due date associated with the task 114; a user, project, or team associated with the task 114; a date or time at which the task 114 has been flagged; whether or not the task 114 is flagged; a location associated with the task 114; a relative weight, importance, or priority associated with the task 114; a completion state associated with the task 114; deletion of the task 114; combinations thereof; and the like. As such, the task 114 can be modified in any way in operation 306, if at all.

If the task engine 102 determines that a task 114 and/or data associated with the task 114 has been modified, the method 300 proceeds to operation 308. In operation 308, the task engine 102 edits one or more tasks 114 stored in the cache 116. In light of the description of operation 306 above, it can be appreciated that operation 308 can include editing any aspect of the task 114, if desired. Any modifications determined in operation 306 to have been made to the task 114 can be written to the tasks 114 in the cache 116. If the tasks 114 are obtained directly from the task systems 112 without caching, operation 308 can include modifying the tasks 114 stored at the task systems 112.

From operation 308, the method 300 proceeds to operation 310, wherein the task engine 102 writes the modified tasks 114 in the cache 116 to the task systems 112. If the tasks 114 have been obtained directly from the task systems 112 without caching, operation 310 can be skipped, as changes can be made directly to the tasks 114 stored by the task systems 112 in operation 308 instead. In other embodiments, the tasks 114 are cached, and operation 310 includes accessing the task systems 112 to write the modified tasks 114 to the task systems 112.

From operation 310, or from operation 306 if the task engine 102 determines that a task 114 and/or data associated with the task 114 has not been modified, the method 300 proceeds to operation 312. The method 300 ends at operation 312.

Turning now to FIG. 4A, a UI diagram showing aspects of a UI for presenting tasks 114 in some embodiments will be described. In particular, FIG. 4A shows a screen display 400A generated by the task engine 102 configured to provide the functionality here for presenting the tasks 114. In some embodiments, the screen display 400A is generated by the presentation module 110 in operation 304 of the method 300 illustrated in FIG. 3. It should be understood that this embodiment is illustrative, and should not be construed as being limiting in any way.

The screen display 400A can correspond to the UIs 118 illustrated in FIG. 1. As such, the screen display 400A can be presented to a user or other entity by a web browser or other application executed by a client device 120. It should be appreciated that the UI diagram illustrated in FIG. 4A is illustrative of one contemplated embodiment, and therefore should not be construed as being limiting in any way.

The screen display 400A shown in FIG. 4A includes various menu items 402. It should be understood that the illustrated menu items 402 are illustrative and that additional and/or alternative menu items are possible and are contemplated. In particular, various icons, command ribbons, input boxes, and/or other UI controls for viewing and/or interacting with the result page can be presented on the screen display 400A without departing from the scope of the appended claims. The screen display 400A also is illustrated as including a search query input box 404 for inputting a search string for searching through tasks 114, for searching a site associated with the task engine 102, for searching the task systems 112, and/or for other purposes. Although not shown in FIG. 4A, other search boxes can be included. For example, in some embodiments a search box for filtering tasks 114 inline is provided. The filtering also can be performed on tasks 114 based upon a location, group, title, or due date associated with the tasks 114, as well as based upon other aspects of the tasks 114.

As mentioned above, the screen display 400A is configured to present tasks 114 to a user or other entity. Because the tasks 114 can be passed to other entities via the API 122 of the task engine 102, it should be understood that the information illustrated in FIGS. 4A-4E can be passed to any number of devices or entities with or without rendering the information. As such, the screen display 400A also is illustrative of various aspects of the concepts and technologies disclosed herein for aggregating and presenting tasks 114.

The screen display 400A includes a task list 406. The task list 406 includes a list of tasks 408A-D (hereinafter collectively and/or generically referred to as “tasks 408”) that are associated with a user or work the user is involved with. It can be appreciated that the tasks 408 presented in the task list 406 can correspond to the tasks 114 described hereinabove with reference to FIGS. 1-3. In some embodiments, the tasks 408 are displayed in the task list 406 as being categorized under various headings 410A-C (hereinafter collectively and/or generically referred to as “headings 410”). As shown in FIG. 4A, another layer under the headings can be included for grouping tasks based upon a project associated with the tasks, based upon a custom group associated with the tasks, and/or based upon other groupings or categories associated with the tasks. This layer is shown in FIG. 4A as a “locations” heading 410C. It should be understood that this embodiment is illustrative, and should not be construed as being limiting in any way.

In the illustrated embodiment, the headings 410 include an “Important Tasks” heading 410A under which one or more tasks 408 that have been flagged by a user or other entity can be displayed, an “Overdue & Upcoming Tasks” heading 410B under which tasks that are overdue or have upcoming due dates can be displayed. As illustrated in FIG. 4A, tasks 408 can appear under more than one heading 410, though this is not necessarily the case. Because additional and/or alternative headings 410 are contemplated, it should be understood that the illustrated embodiment is illustrative, and should not be construed as being limiting in any way.

The tasks 408 shown in the screen display 400A can be provided with the ability to edit the tasks 408 in-line. Thus, a user or other entity can interact with the tasks 408 shown in the screen display 400A, and modifications made to the displayed task 408 can be detected by the task engine 102 and written to the associated tasks 114. As explained above, changes made to the tasks 408 via the functionality described with respect to the screen display 400A can be written to tasks 114 stored in the cache 116 and/or tasks 114 hosted by the task systems 112.

The presentation module 110 also supports various other operations that are shown in the screen display 400A. For example, the screen display 400A can include a UI control 412, the selection of which allows a user or other entity to create a new task 114. Selection of the UI control 412 can prompt the presentation module 110 to present an input screen or in-line form for inputting the new task, if desired. The screen display 400A also can include a UI control 414, the selection of which causes the task aggregator 108 to move or copy a task represented by the task 408B to other members of a group associated with the task 408B. As such, tasks 114 can be shared with other members of a group, if desired. It should be understood that these embodiments are illustrative, and should not be construed as being limiting in any way.

In some embodiments, the screen display 400A also includes a timeline 416. The timeline 416 can be used to present visual representations of tasks 114 to a user or other entity. According to some embodiments, the timeline 416 is presented using a sliding time window that can be set or adjusted by a user or software setting. In some embodiments, tasks 114 displayed on the timeline 416 can be color coded based upon a location from which the tasks 114 come from, based upon projects or other groupings, based upon importance flags or due dates associated with the tasks 114, and/or based upon other considerations. The sliding time window in the illustrated embodiment includes one week in the past and two weeks of the future. Due dates within this three week time window are shown on the timeline 416 so users can see overdue and upcoming dates. It can be appreciated that the timeline 416 can, but does not necessarily, display tasks 408 listed under the “Overdue & Upcoming Tasks” heading 410B. Also, in some embodiments users can selectively add tasks 408 to the timeline 416. For example, in the illustrated embodiment users add tasks 408 to the timeline 416 by selecting a UI control such as the UI control 418 shown next to the task 408D. As mentioned above, the tasks 114 can be filtered. It should be noted that any or all of the tasks 114 can be filtered including, but not limited to, tasks 114 shown on the timeline 416. It should be understood that this embodiment is illustrative, and should not be construed as being limiting in any way.

It should be understood that the various UI controls described herein with reference to FIG. 4A can be interacted with using a variety of movements, input devices, and/or gestures, depending upon an input and/or display device employed by a user. According to some embodiments, for example, the UI controls can be selected by a user hovering a mouse pointer or other input device over one of the UI controls; by clicking at or near one of the UI controls with a mouse or other input device; by touching the display or screen with one or more fingers, styluses, and/or other structures or devices at or near the displayed UI controls; by submitting a voice command; by submitting commands via one or more key strokes or other input; combinations thereof; and the like. Because the concepts and technologies disclosed herein can be used with various devices that support a number of input devices and/or controls, the above list of commands is to be viewed as illustrative, and not limiting in any way the types of input and/or devices that can be used to view and/or access the tasks 114.

Turning now to FIG. 4B, a UI diagram showing aspects of a UI for presenting tasks 114 in another embodiment will be described. The UI illustrated in FIG. 4B can be, but is not necessarily, generated by the task engine 102 in response to receiving selection of one of the tasks 408 illustrated in FIG. 4A. Thus, selection of a task 408 in the screen display 400A can prompt the task engine 102 to present additional details associated with the selected task 408. It should be appreciated that the UI diagram illustrated in FIG. 4B is illustrative of one contemplated embodiment, and therefore should not be construed as being limiting in any way.

The screen display 400B includes a task window 420. The task window 420 is illustrated as displaying additional details associated with the selected task 408. As shown in FIG. 4B, the task window 420 includes a task title, a creation date, a completion date or deadline, a completion state, a location associated with the task system 112 hosting the task 114, and other information such as a project or team with which the task is associated, information about the project or team, and/or other information about the task 114. In some embodiments, some, none, or all elements of the context information can be interactive and can, for example, allow users to navigate to project or team sites, post information status to the sites, and/or take other actions with respect to the information. It should be understood that this embodiment is illustrative, and should not be construed as being limiting in any way.

Turning now to FIG. 4C, a UI diagram showing aspects of a UI for viewing tasks 114 in another embodiment will be described. The UI illustrated in FIG. 4C can be, but is not necessarily, generated by the task engine 102 in operation 304 of the method 300 illustrated and described with respect to FIG. 3. In some embodiments, the embodiment illustrated in FIG. 4C is a default view provided by the task engine 102 for presenting the tasks 114. FIG. 4C shows a screen display 400C generated by the task engine 102 to present the tasks 114 in an active view 430 that displays any identified tasks. The tasks 114 shown in the active view 430 can, but do not necessarily, include any identified tasks 114, regardless of an importance associated with the respective tasks 114, whether the tasks 114 have been flagged by users, respective completion states, and/or due dates. It should be appreciated that the UI diagram illustrated in FIG. 4C is illustrative of one contemplated embodiment, and therefore should not be construed as being limiting in any way.

Turning now to FIG. 4D, a UI diagram showing aspects of a UI for viewing tasks 114 in another embodiment will be described. The UI illustrated in FIG. 4D can be, but is not necessarily, generated by the task engine 102 in operation 304 of the method 300 illustrated and described with respect to FIG. 3. Some, all, or none of the aspects of the screen display 400D shown in FIG. 4D can be included with any of the screen displays 400 shown in FIGS. 4A-4C and/or 4E, if desired. The screen display 400D includes a new tasks view 440 for displaying tasks 114 that have been recently identified by the task engine 102. For purposes of FIG. 4D, “recent tasks” include tasks 114 that have been identified since a previous rendering and/or during a most recent cache refresh operation.

It can be appreciated that some tasks 114 may or may not be displayed on the timeline 416, depending upon due dates associated with the tasks 114. For example, in FIG. 4D, the task 408E has a due date outside of the time window displayed by the timeline 416 and therefore is not shown as displayed on the timeline 416. It should be appreciated that the UI diagram illustrated in FIG. 4D is illustrative of one contemplated embodiment, and therefore should not be construed as being limiting in any way.

The screen display 400D also displays a UI control 442 for accessing a “status reporting view” and/or a “timesheet view.” Selection of the UI control 442 can prompt the task engine 102 to launch one or more dialogs that host a Project Server Statusing feature for loading a Project Server site collection of tasks 114. The UI control 442 also can be presented as an option in the view selector 444 instead of, or in addition to, being presented in the illustrated location. Thus, the “status reporting view” can be presented as an extensibility option of the UI diagram based upon a selected provider. As such, it should be understood that the illustrated embodiment is illustrative, and should not be construed as being limiting in any way.

Turning now to FIG. 4E, a UI diagram showing aspects of a UI for viewing tasks 114 in another embodiment will be described. Some, all, or none of the aspects of the screen display 400E shown in FIG. 4E can be included with any of the screen displays 400 shown in FIGS. 4A-4E, if desired. The screen display 400E includes a completed tasks view 450 for displaying tasks 114 that have been marked by a user or other entity as being completed. In one contemplated embodiment, tasks 114 marked as completed in other views can be animated to provide feedback to users and/or to provide users with satisfaction at having completed the tasks 114. One contemplated example of such feedback, wherein strikethrough is used, is illustrated in FIG. 4F. In other embodiments, completed tasks 114 are removed or disappear to illustrate completion of the tasks 114. It should be appreciated that the UI diagrams illustrated in FIGS. 4E-4F are illustrative and therefore should not be construed as being limiting in any way.

In the screen displays 400 illustrated and described above with regard to FIGS. 4A-4E, the tasks 114 can be displayed as UI controls that allow various in-line editing processes to be completed by users. Illustrative editing processes include, but are not limited to, an ability to edit inline a title, due date, importance flag, completion state, or other information associated with the task 114; an ability to launch a task form for the task 114 to view and/or edit granular details associated with the task 114; groupings indicating a project, a site, a system, and/or a location with which the task 114 is associated, which can be provider or task system 112 dependent; a launch point to display metadata for the task 114, wherein the metadata can include context information that may be useful for users attempting to complete work associated with the task 114 such as related tasks 114, a project associated with the task 114, related documents, and/or other information; an ability to create a new task in a particular section or group or in a new section or group; an ability to drag and drop tasks 114 between groups, to reorder tasks 114; and/or other functionality. For example, although not shown in FIGS. 4A-4F, some embodiments of the concepts and technologies disclosed herein include location groupings under the “Upcoming,” “Active,” “New,” and “Completed” sections and or views. Because other functionality can be included in the screen displays 400, it should be understood that these embodiments are illustrative, and should not be construed as being limiting in any way.

While the above description has referred to aggregating tasks 114 from task systems 112 and presenting the tasks 114 in various user interfaces 118, it should be understood that the functionality described herein can be used to aggregate and organize tasks 114 without necessarily presenting the tasks 114 in a user interface 118. Furthermore, the UIs 118 described herein are illustrative and must not be construed as being limiting in any way. The concepts and technologies disclosed herein support extensibility of the UIs 118 based upon needs or desires of tasks systems 112. Thus, the UIs 118 can be tailored to present or suppress information as desired by authorized entities associated with the task systems 112.

As explained above, tasks 114 can be marked as “important” in some, all, or none of the various UIs 118. According to some embodiments, a time at which a task 114 is marked as being important can be tracked and/or logged. The importance flag can be, but is not necessarily, set to expire after a set or specified amount of time passes after marking the event or task 114 as being important. As such, lists tracking important or flagged items can be trimmed or otherwise managed. It should be understood that this embodiment is illustrative, and should not be construed as being limiting in any way.

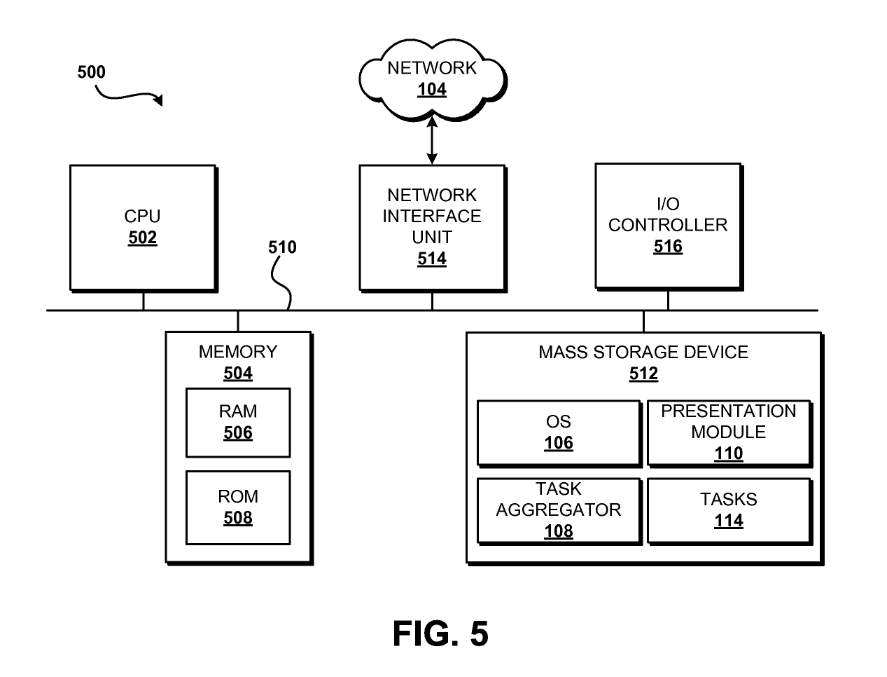

FIG. 5 illustrates an illustrative computer architecture 500 for a device capable of executing the software components described herein for aggregating and presenting tasks. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 106, the task aggregator 108, the presentation module 110, and/or other application programs. The mass storage device 512 also can be configured to store the tasks 114 and/or other data, if desired. As such, it can be appreciated that the mass storage device 512 can provide the functionality associated with the cache 116 described above with reference to FIG. 1, though the cache 116 is not shown in FIG. 5.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium” and variations thereof, does not include waves, signals, and/or other transitory and/or intangible communication media, per se.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the task systems 112, the client device 120, and/or other systems or devices. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

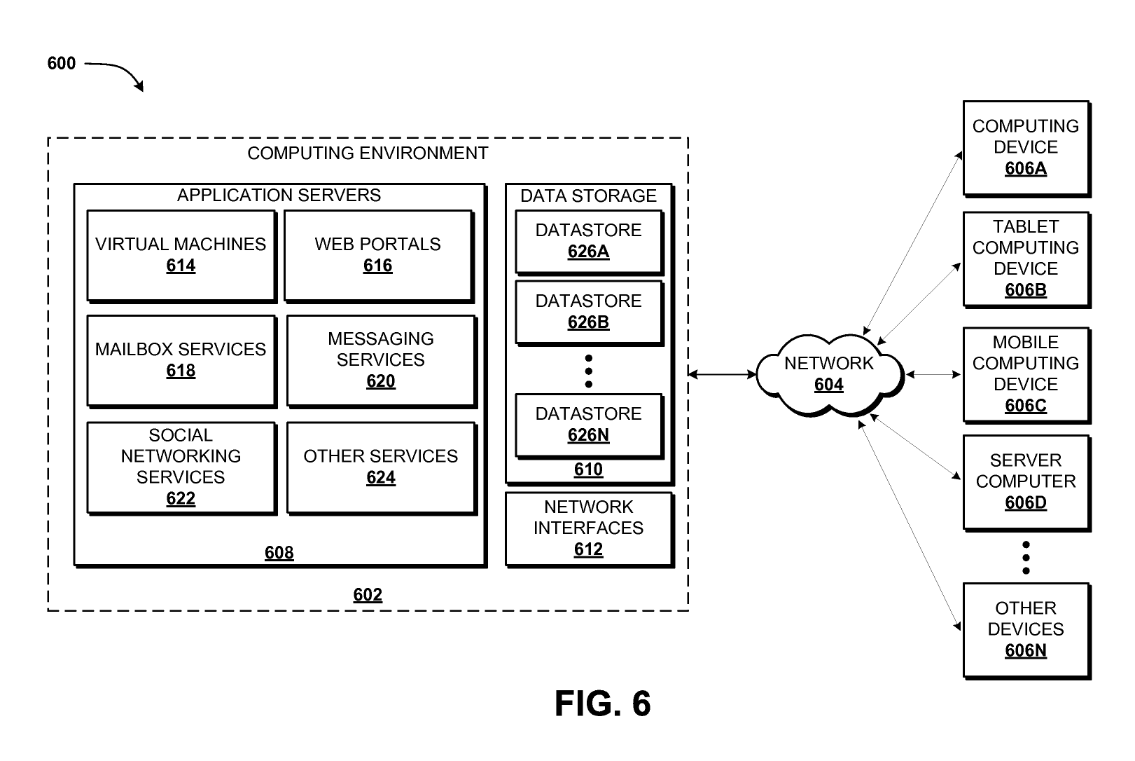

FIG. 6 illustrates an illustrative distributed computing environment 600 capable of executing the software components described herein for aggregating and presenting tasks. Thus, the distributed computing environment 600 illustrated in FIG. 6 can be used to provide the functionality described herein with respect to the task engine 102. The distributed computing environment 600 thus may be utilized to execute any aspects of the software components presented herein.

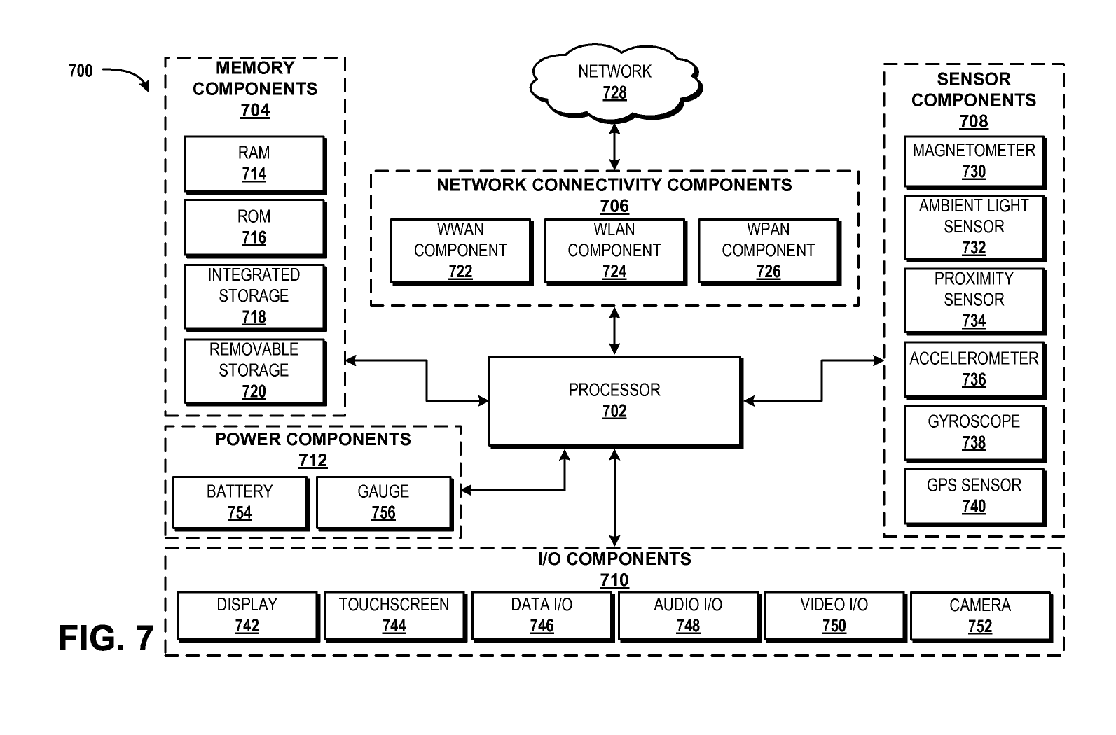

According to various implementations, the distributed computing environment 600 includes a computing environment 602 operating on, in communication with, or as part of the network 604. The network 604 also can include various access networks. According to various implementations, the functionality of the network 604 is provided by the network 104 illustrated in FIGS. 1 and 5. One or more client devices 606A-606N (hereinafter referred to collectively and/or generically as “clients 606”) can communicate with the computing environment 602 via the network 604 and/or other connections (not illustrated in FIG. 6). In the illustrated embodiment, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limiting in any way.

In the illustrated embodiment, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated embodiment, the application servers 608 host one or more virtual machines 614 for hosting applications or other functionality. According to various implementations, the virtual machines 614 host one or more applications and/or software modules for providing the functionality described herein for aggregating and presenting tasks. It should be understood that this embodiment is illustrative, and should not be construed as being limiting in any way. The application servers 608 also host or provide access to one or more Web portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also can include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 622 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above embodiments are illustrative, and should not be construed as being limiting in any way.

As shown in FIG. 6, the application servers 608 also can host other services, applications, portals, and/or other resources (“other resources”) 624. The other resources 624 can include, but are not limited to, the task systems 112. It thus can be appreciated that the computing environment 602 can provide integration of the concepts and technologies disclosed herein provided herein for aggregating and presenting tasks with various mailbox, messaging, social networking, and/or other services or resources. For example, the concepts and technologies disclosed herein can be used to aggregate and present social networking or messaging tasks, tasks associated with various personal information management software, and the like. Additionally, users can share information associated with their tasks 114 with a social network, create messages associated with tasks 114, and/or take other actions with regard to the tasks 114.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store the cache 116, the tasks 114, and the UIs 118, if desired>.>

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 600 to utilize the functionality described herein for aggregating and presenting tasks.

Turning now to FIG. 7, an illustrative computing device architecture 700 for a computing device that is capable of executing various software components described herein for aggregating and presenting tasks. The computing device architecture 700 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 700 is applicable to any of the clients 706 shown in FIG. 6. Furthermore, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated embodiment, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some embodiments, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some embodiments, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some embodiments, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some embodiments, the processor 702 is fabricated, in part, utilizing a package-on-package (“PoP”) integrated circuit packaging technique. Moreover, the processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some embodiments, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex,, a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some embodiments, the RAM 714 or a portion thereof, the ROM 716 or a portion thereof, and/or some combination the RAM 714 and the ROM 716 is integrated in the processor 702. In some embodiments, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some embodiments, the removable storage 720 is provided in lieu of the integrated storage 718. In other embodiments, the removable storage 720 is provided as additional optional storage. In some embodiments, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from a network 728, which may be a WWAN, a WLAN, or a WPAN. Although a single network 728 is illustrated, the network connectivity components 706 may facilitate simultaneous communication with multiple networks. For example, the network connectivity components 706 may facilitate simultaneous communications with multiple networks via one or more of a WWAN, a WLAN, or a WPAN. In some embodiments, the network 728 is provided by one or more of the networks 104, 604. In some embodiments, the network 728 includes the networks 104, 604. In yet other embodiments, the network 728 provides access to the networks 104, 604.

The network 728 may be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 728 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 728 may be configured to provide voice and/or data communications with any combination of the above technologies. The network 728 may be configured to or adapted to provide voice and/or data communications in accordance with future generation technologies.

In some embodiments, the WWAN component 722 is configured to provide dual- multi-mode connectivity to the network 728. For example, the WWAN component 722 may be configured to provide connectivity to the network 728, wherein the network 728 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 728 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 724 is configured to connect to the network 728 via the WI-FI access points. Such connections may be secured via various encryption technologies including, but not limited, WI-FI Protected Access (“WPA”), WPA2, Wired Equivalent Privacy (“WEP”), and the like.

The network 728 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 726 is configured to facilitate communications with other devices, such as peripherals, computers, or other computing devices via the WPAN.

The sensor components 708 include a magnetometer 730, an ambient light sensor 732, a proximity sensor 734, an accelerometer 736, a gyroscope 738, and a Global Positioning System sensor (“GPS sensor”) 740. It is contemplated that other sensors, such as, but not limited to, temperature sensors or shock detection sensors, also may be incorporated in the computing device architecture 700.

The magnetometer 730 is configured to measure the strength and direction of a magnetic field. In some embodiments the magnetometer 730 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 730 are contemplated.

The ambient light sensor 732 is configured to measure ambient light. In some embodiments, the ambient light sensor 732 provides measurements to an application program stored within one the memory components 704 in order to automatically adjust the brightness of a display (described below) to compensate for low-light and high-light environments. Other uses of measurements obtained by the ambient light sensor 732 are contemplated.

The proximity sensor 734 is configured to detect the presence of an object or thing in proximity to the computing device without direct contact. In some embodiments, the proximity sensor 734 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 734 are contemplated.

The accelerometer 736 is configured to measure proper acceleration. In some embodiments, output from the accelerometer 736 is used by an application program as an input mechanism to control some functionality of the application program. For example, the application program may be a video game in which a character, a portion thereof, or an object is moved or otherwise manipulated in response to input received via the accelerometer 736. In some embodiments, output from the accelerometer 736 is provided to an application program for use in switching between landscape and portrait modes, calculating coordinate acceleration, or detecting a fall. Other uses of the accelerometer 736 are contemplated.

The gyroscope 738 is configured to measure and maintain orientation. In some embodiments, output from the gyroscope 738 is used by an application program as an input mechanism to control some functionality of the application program. For example, the gyroscope 738 can be used for accurate recognition of movement within a 3D environment of a video game application or some other application. In some embodiments, an application program utilizes output from the gyroscope 738 and the accelerometer 736 to enhance control of some functionality of the application program. Other uses of the gyroscope 738 are contemplated.

The GPS sensor 740 is configured to receive signals from GPS satellites for use in calculating a location. The location calculated by the GPS sensor 740 may be used by any application program that requires or benefits from location information. For example, the location calculated by the GPS sensor 740 may be used with a navigation application program to provide directions from the location to a destination or directions from the destination to the location. Moreover, the GPS sensor 740 may be used to provide location information to an external location-based service, such as E911 service. The GPS sensor 740 may obtain location information generated via WI-FI, WIMAX, and/or cellular triangulation techniques utilizing one or more of the network connectivity components 706 to aid the GPS sensor 740 in obtaining a location fix. The GPS sensor 740 may also be used in Assisted GPS (“A-GPS”) systems.

The I/O components 710 include a display 742, a touchscreen 744, a data I/O interface component (“data I/O”)746, an audio I/O interface component (“audio I/O”) 748, a video I/O interface component (“video I/O”) 750, and a camera 752. In some embodiments, the display 742 and the touchscreen 744 are combined. In some embodiments two or more of the data I/O component 746, the audio I/O component 748, and the video I/O component 750 are combined. The I/O components 710 may include discrete processors configured to support the various interface described below, or may include processing functionality built-in to the processor 702.

The display 742 is an output device configured to present information in a visual form. In particular, the display 742 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 742 is a liquid crystal display (“LCD”) utilizing any active or passive matrix technology and any backlighting technology (if used). In some embodiments, the display 742 is an organic light emitting diode (“OLED”) display. Other display types are contemplated.

The touchscreen 744 is an input device configured to detect the presence and location of a touch. The touchscreen 744 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 744 is incorporated on top of the display 742 as a transparent layer to enable a user to use one or more touches to interact with objects or other information presented on the display 742. In other embodiments, the touchscreen 744 is a touch pad incorporated on a surface of the computing device that does not include the display 742. For example, the computing device may have a touchscreen incorporated on top of the display 742 and a touch pad on a surface opposite the display 742.

In some embodiments, the touchscreen 744 is a single-touch touchscreen. In other embodiments, the touchscreen 744 is a multi-touch touchscreen. In some embodiments, the touchscreen 744 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 744. As such, a developer may create gestures that are specific to a particular application program.

In some embodiments, the touchscreen 744 supports a tap gesture in which a user taps the touchscreen 744 once on an item presented on the display 742. The tap gesture may be used for various reasons including, but not limited to, opening or launching whatever the user taps. In some embodiments, the touchscreen 744 supports a double tap gesture in which a user taps the touchscreen 744 twice on an item presented on the display 742. The double tap gesture may be used for various reasons including, but not limited to, zooming in or zooming out in stages. In some embodiments, the touchscreen 744 supports a tap and hold gesture in which a user taps the touchscreen 744 and maintains contact for at least a pre-defined time. The tap and hold gesture may be used for various reasons including, but not limited to, opening a context-specific menu.

In some embodiments, the touchscreen 744 supports a pan gesture in which a user places a finger on the touchscreen 744 and maintains contact with the touchscreen 744 while moving the finger on the touchscreen 744. The pan gesture may be used for various reasons including, but not limited to, moving through screens, images, or menus at a controlled rate. Multiple finger pan gestures are also contemplated. In some embodiments, the touchscreen 744 supports a flick gesture in which a user swipes a finger in the direction the user wants the screen to move. The flick gesture may be used for various reasons including, but not limited to, scrolling horizontally or vertically through menus or pages. In some embodiments, the touchscreen 744 supports a pinch and stretch gesture in which a user makes a pinching motion with two fingers (e.g., thumb and forefinger) on the touchscreen 744 or moves the two fingers apart. The pinch and stretch gesture may be used for various reasons including, but not limited to, zooming gradually in or out of a website, map, or picture.

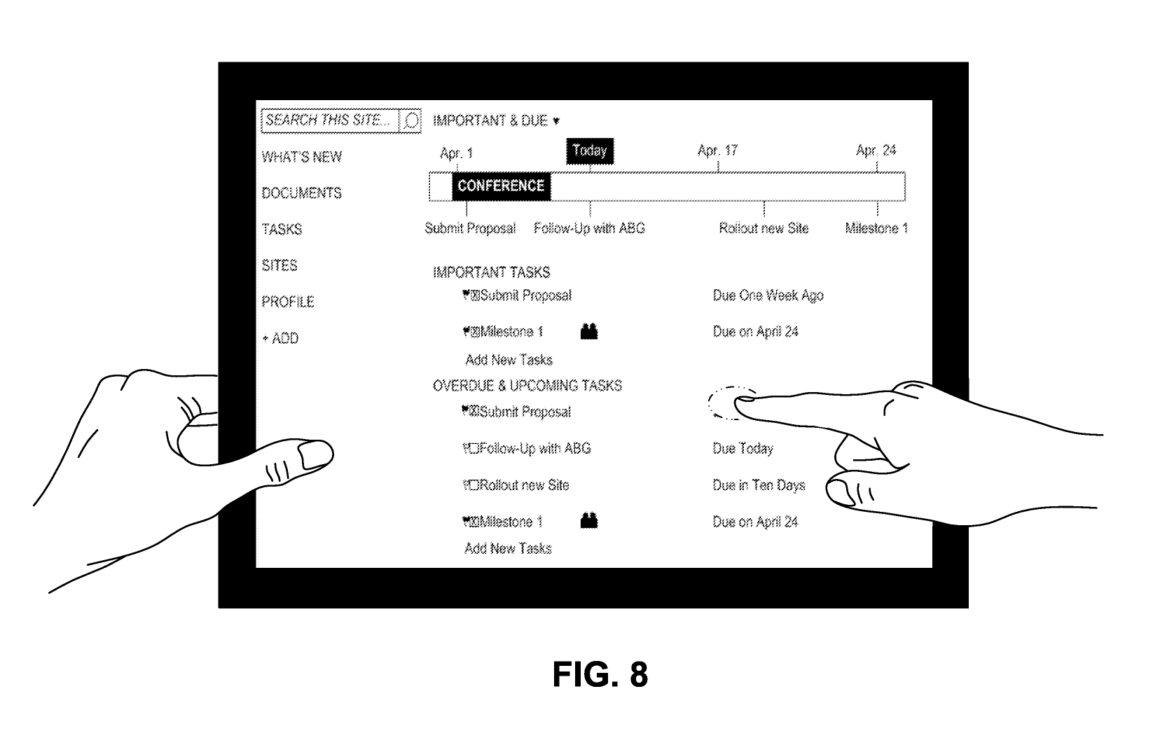

Although the above gestures have been described with reference to the use one or more fingers for performing the gestures, other appendages such as toes or objects such as styluses may be used to interact with the touchscreen 744. As such, the above gestures should be understood as being illustrative and should not be construed as being limiting in any way. An example user interface using a touch interface is shown in FIG. 8.

The data I/O interface component 746 is configured to facilitate input of data to the computing device and output of data from the computing device. In some embodiments, the data I/O interface component 746 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 748 is configured to provide audio input and/or output capabilities to the computing device. In some embodiments, the audio I/O interface component 746 includes a microphone configured to collect audio signals. In some embodiments, the audio I/O interface component 746 includes a headphone jack configured to provide connectivity for headphones or other external speakers. In some embodiments, the audio interface component 748 includes a speaker for the output of audio signals. In some embodiments, the audio I/O interface component 746 includes an optical audio cable out.

The video I/O interface component 750 is configured to provide video input and/or output capabilities to the computing device. In some embodiments, the video I/O interface component 750 includes a video connector configured to receive video as input from another device (e.g., a video media player such as a DVD or BLURAY player) or send video as output to another device (e.g., a monitor, a television, or some other external display). In some embodiments, the video I/O interface component 750 includes a High-Definition Multimedia Interface (“HDMI”), mini-HDMI, micro-HDMI, DisplayPort, or proprietary connector to input/output video content. In some embodiments, the video I/O interface component 750 or portions thereof is combined with the audio I/O interface component 748 or portions thereof.

The camera 752 can be configured to capture still images and/or video. The camera 752 may utilize a charge coupled device (“CCD”) or a complementary metal oxide semiconductor (“CMOS”) image sensor to capture images. In some embodiments, the camera 752 includes a flash to aid in taking pictures in low-light environments. Settings for the camera 752 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 754, which can be connected to a battery gauge 756. The batteries 754 may be rechargeable or disposable. Rechargeable battery types include, but are not limited to, lithium polymer, lithium ion, nickel cadmium, and nickel metal hydride. Each of the batteries 754 may be made of one or more cells.

The battery gauge 756 can be configured to measure battery parameters such as current, voltage, and temperature. In some embodiments, the battery gauge 756 is configured to measure the effect of a battery's discharge rate, temperature, age and other factors to predict remaining life within a certain percentage of error. In some embodiments, the battery gauge 756 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via a power I/O component 744.

Based on the foregoing, it should be appreciated that technologies for aggregating and presenting tasks have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for presenting tasks, the computer-implemented method comprising performing computer-implemented operations for:
obtaining the tasks at a task engine, the tasks comprising a first task associated with a first task system and a second task associated with a second task system;
rendering the tasks in a user interface;
presenting the user interface;
determining if one of the tasks presented in the user interface has been modified; and
in response to determining that one of the tasks has been modified, writing the change to one or more of the first task at the first task system or the second task at the second task system.

2. The method of claim 1, wherein obtaining the tasks comprises
communicating with the first task system,
obtaining the first task from the first task system, and
storing the first task in a data storage device associated with the task engine.

3. The method of claim 2, further comprising:
in response to determining that the one of the tasks has been modified, editing the first task stored in the data storage device to reflect the change.

4. The method of claim 3, wherein the data storage device comprises a cache hosted by the task engine.

5. The method of claim 1, wherein the tasks comprise data indicating at least one of a due date or a completion date.

6. The method of claim 5, wherein presenting the user interface comprises:
presenting a first view comprising a timeline for displaying tasks that have a due date or a completion date within a time window displayed by the timeline; and
displaying a task list for displaying the tasks.

7. The method of claim 6, wherein the tasks further comprise data indicating a location associated with the tasks and a completion state associated with the tasks.

8. The method of claim 7, further comprising:
obtaining the tasks by
communicating with the first task system,
obtaining the first task from the first task system, and
storing the first task in a data storage device associated with the task engine; and
refreshing the cache after presenting the user interface.

9. The method of claim 1, wherein the tasks comprise data indicating at least one of a due date, a completion date, or a location, and wherein presenting the user interface comprises presenting at least one of the tasks with a user interface control selectable to display, for the at least one of the tasks, the data.

10. The method of claim 1, wherein obtaining the tasks comprises embedding an external reference for each of the tasks in the user interface.

11. A computer storage medium having computer readable instructions stored thereupon that, when executed by a computer, cause the computer to:
obtain a plurality of tasks at a task engine, the plurality of tasks comprising a first task associated with a first task system and a second task associated with a second task system;
render the tasks in a user interface generated by a presentation module executed by the task engine;
present the user interface;
determine if one of the plurality of tasks presented in the user interface has been modified via the user interface; and
in response to determining that one of the tasks has been modified, modify at least one of a version of first task hosted at the first task system or a version of the second task hosted at the second task system.

12. The computer storage medium of claim 11, further comprising computer-executable instructions that, when executed by the computer, cause the computer to:
communicate with the first task system to obtain a copy of the first task from the first task system;
communicate with the second task system to obtain a copy of the second task from the second task system;
store the copy of the first task and the copy of the second task in a cache provided by a data storage device of the task engine; and
in response to determining that the one of the tasks has been modified, edit at least one of the copy of first task or the copy of the second task stored in the cache in accordance with the change.

13. The computer storage medium of claim 11, wherein the tasks comprise data including one or more of
a title of the task,
a location associated with a task system associated with the task,
a due date associated with the task, or
a completion state associated with the task.

14. The computer storage medium of claim 11, wherein presenting the user interface comprises at least one of:
presenting a first view comprising a timeline for displaying tasks that have a due date or a completion date within a time window displayed by the timeline and a task list for displaying the tasks;
presenting a second view comprising a list of tasks that have been added since a previous cache update;
presenting a third view comprising a list of tasks that have been marked as completed; or
presenting a fourth view comprising any tasks associated with a user associated with an entity viewing the user interface.

15. The computer storage medium of claim 14, further comprising computer-executable instructions that, when executed by the computer, cause the computer to:
receive data indicating selection of data indicating that one or more of the tasks has been marked as completed; and
present the third view, in response to receiving the data.

16. The computer storage medium of claim 14, further comprising computer-executable instructions that, when executed by the computer, cause the computer to:
present, in the user interface, a first user interface control for marking one or more of the tasks with an importance indicator;
present, in the user interface, a second user interface control for marking one or more of the tasks as complete; and
present, in the user interface, a third user interface control for editing a title and a due date of one or more of the tasks inline within the user interface.

17. The computer storage medium of claim 11, wherein obtaining the tasks comprises embedding an external reference for each of the tasks in the user interface.

18. A computer storage medium having computer readable instructions stored thereupon that, when executed by a computer, cause the computer to:
communicate with a plurality of task systems in communication with a task engine, each of the plurality of task systems storing one or more tasks;
obtain, at the task engine, copies of each of the one or more task stored by the task systems, the copies of the tasks being received via an application programming interface exposed by the task engine;
store, at a cache associated with the task engine, the copies of the tasks;
render a user interface for presenting the copies of the tasks;
present the user interface;
determine if one of the plurality of tasks presented in the user interface has been modified via the user interface; and
in response to determining that one of the tasks has been modified, modify at least one of the tasks stored by at least one of the task systems.

19. The computer storage medium of claim 18, wherein presenting the user interface comprises at least one of:
presenting a first view comprising a timeline for displaying tasks that have a due date or a completion date within a time window displayed by the timeline and a task list for displaying the tasks;
presenting a second view comprising a list of tasks that have been added since a previous cache update;
presenting a third view comprising a list of tasks that have been marked as completed; or presenting a fourth view comprising at least one of tasks associated with a user associated with an entity viewing the user interface or tasks that have not been completed.

20. The computer storage medium of claim 18, further comprising computer-executable instructions that, when executed by the computer, cause the computer to:
present, in the user interface, a first user interface control for marking one or more of the tasks with an importance flag;
present, in the user interface, a second user interface control for marking one or more of the tasks as complete; and
present, in the user interface, a third user interface control for editing a title and due date of one or more of the tasks inline within the user interface.
